(19) United States
(12) Patent Application Publication
(10) Pub. No.: US 2005/0167487 A1
(43) Pub. Date: Aug. 4, 2005

(54) System and method for customizing designs for credit cards, ATM/debit cards, checks, gift cards, and membership cards

(76) Inventors: Jennifer L. Conlon, Nederland, CO (US); Jon M. Whitacre, Nederland, CO (US)

Correspondence Address: LITMAN LAW OFFICES, LTD, PO BOX 15035, CRYSTAL CITY STATION, ARLINGTON, VA, 22215, US

(21) Appl. No.: 11/047,593

(22) Filed: Feb. 2, 2005

Related U.S. Application Data
(60) Provisional application No. 60/540,345, filed on Feb. 2, 2004.

(51) Int. Cl. G06K 5/00

(52) U.S. Cl. 235/380

(57) ABSTRACT

The system and method for customizing credit cards, ATM/debit cards, gift cards, checks, membership cards and the like allows a user to create personalized products with a combination of images, text or sound clips using a kiosk, the Internet or stand-alone software. The user selects a product to create, such as a check, a gift card, a credit card or similar card. Next, the user places and arranges artwork on the selected product according to the user's preference. The image may be selected from a stored library, a scanned image, a memory device or an active camera. The user may also opt to add text or a sound clip to the product. Once the product is customized the user may install a money value on the product, if appropriate, and purchase any quantity of the customized product. The customized product is printed as the user waits.

### CROSS-REFERENCE TO RELATED APPLICATION

This application claims the benefit of U.S. Provisional Patent Application Ser. No. 60/540,345, filed Feb. 2, 2004.

### BACKGROUND OF THE INVENTION

1. Field of the Invention

The present invention relates to a system and method for customizing designs for financial and non-financial instruments such as credit cards, ATM/debit cards, checks, gift cards, membership cards and the like, using images, text and sound clips.

2. Description of the Related Art

The financial services industry and retailers have developed a broad range of products to accommodate their clients in the last several years. This has resulted in users developing their own designs for not only a variety of financial instruments, such as credit cards, ATM/debit cards and checks, gift certificates, gift cards, but also for non-financial instruments, such as membership cards and the like. This is reflected in the related art.

U.S. patent Publication Number 2003/0088514, published on May 8, 2003 and applied for by Sesek, outlines the use of a check drafted upon an account with a financial institution generated from an ATM interface. A unique identifier is discovered for the account and either the unique identifier or account information encoded on a magnetic strip is read. If the account information is read, the unique identifier is retrieved from a database of account information.

Authorization to draft the check on the account is also verified.

U.S. patent Publication No. 2003/0160444, published on Aug. 28, 2003 and applied for by Durso, outlines the use of a personalized phone card that is designed to display a person's photograph and personal information, while also providing the holder of the card with phone card services. The phone card has a front surface and a back surface, the front surface of the phone card having a picture of the user along with information on how to use the card and the telephone number of the person pictured on the front of the card.

U.S. Pat. No. 3,692,298, issued to Peacock on Sep. 19, 1972, outlines the inexpensive printing of individual checkbooks containing personalized checks and other documents with flexibility in the order of such documents in checkbook. The unvarying information and background patterns are bulk-printed on a Web page, or on large sheets, and are then cut into individual checks.

U.S. Pat. No. 4,318,554, issued to Anderson et al. on Mar. 9, 1982, outlines the use of a medical and/or informational identification credit card with multiple laminar parts, partially heat-sealed in a localized area to permit high speed embossment in automatic equipment, whereupon a customized information part, such as a microfilm chip or photograph, matched to the embossed identification on the partially laminated card, may be inserted and locked in place by a full lamination of the card.

U.S. Pat. No. 4,772,782, issued to Nonat on Sep. 20, 1988, outlines the use of a method for personalizing portable media, such as cards having memory, with writing personalizing data into each card prior to its being put into service. For a mixed card, personalizing data is written onto magnetic track, onto the card itself, and into the memory of the card at the workstation.

U.S. Pat. No. 5,066,047, issued to Mailloux et al. on Nov. 19, 1991, outlines the use of a laminar structure for an identity card, with a photograph and a supported hologram. A moisture-impermeable barrier layer and an adhesive layer are disposed between the hologram and the photograph, so that the photograph can be secured to the hologram while the former is still wet.

U.S. Pat. No. 5,505,494, issued to Belluci et al. on Apr. 9, 1996 and U.S. patent Reexamination Certificate issued to Belluci et al. on Sep. 29, 1998, outline the use of an identification instrument, such as a pocket-sized card, that includes both human-recognizable and machine-readable indicia.

The human-recognizable material may be any combination of photographs, graphical or textual information, with the machine-readable section encoding any or all of the human-recognizable areas in their entirety.

U.S. Pat. No. 5,838,814, issued to Moore on Nov. 17, 1998, outlines the use of a check-permitting confirmation that is drawn by an authorized maker at the time of transaction disclosure. Such a check includes a picture of the authorized maker and an electronically-scannable method for informing a bank whether the check was transacted with the authorized maker present.

U.S. Pat. No. 5,889,941, issued to Tushie et al. on Mar. 30, 1999, outlines the use of a smart card personalization system that maintains a database containing card issuer data format templates, card applications, card operating system commands and personalization equipment specifications and provides a centralized interface of inputs and outputs to a card issuing process which dynamically adjusts to changes in the issuing process to easily permit a card issuer to change data formats, card applications, card operating systems and personalization equipment in a card issuing process.

U.S. Pat. No. 5,900,954, issued to Katz et al. on May 4, 1999, outlines the use of a record carrier (e.g., an identification card) of the type containing machine-readable representations of data, wherein the record carrier has a substrate, a first pattern of machine-readable indicia applied to one surface of the substrate and a hologram containing machine readable data disposed on one surface of the substrate.

U.S. Pat. No. 5,904,091, issued to Arai on May 18, 1999, outlines the use of an engraved picture bearing certificate with a specular-surfaced engraving sheet, on which an original picture for identification, such as a photograph of a face, a fingerprint, a signature, a logo or the like, is engraved by an engraving tool of an engraving device. The specularly reflected light from the surface of the engraving sheet is visibly recognized as the engraved picture.

U.S. Pat. No. 6,224,109, issued to Yang on May 1, 2001, outlines the use of a credit card with a driver's license for providing credit information to an individual regarding the proof of registration to operate a motor vehicle on a single form of identification. The credit card with driver's license includes a semi-rigid thin piece of material having a face side, a photograph of the individual positioned on the face side, additional identifying information positioned on the face side and a magnetic strip storing information providing access to the credit of the individual and personal information regarding the individual upon reading the magnetic strip by a credit card terminal.

U.S. Pat. No. 6,335,799, issued to Provost on Jan. 1, 2002, outlines the use of an apparatus and method for the immediate issuance of personalized identification cards during client interviews. The invention relates to the creation of personalized cards and the recording of personal information on a real-time basis, while a client is interviewed by a card-issuing authority.

Great Britain Patent No. 2,073,661, published Mar. 20, 1981, outlines an apparatus for providing a personalization of a blank check form with particular customer information for use as identification when the personalized check is presented for cashing, including the storing of information representative of a replica of a particular customer's signature.

French Patent No. 2,788,359, published on Jul. 13, 2000, outlines the use of a card that has a plastic support with a setting zone that includes a display system connected to a chip by a network of conductors. The display system is modified by data transmitted from the chip. The display system contains electronic ink of polarized black and white micro-particles encapsulated in micro-shells. The polarization of ink is modified by a network of conductors, and the card has a plastic support on which a micro-module or chip is placed, which has at least a microprocessor, a programmed memory, data and an input and output interface.

Although each of these patents outline the use of a variety of useful and novel devices and methods, there is a need for a system and method that can aesthetically customize designs for credit cards and other similar financial and retail cards, checks, certificates, instruments that are now commonly used. Such a system and method would be well received in the marketplace by individuals, financial institutions, businesses, as well as by retailers, as providing a broader range of financial service products and capabilities to customers and users.

None of the above inventions and patents, taken either singly or in combination, is seen to describe the instant invention as claimed. Thus, a system and method for customizing financial instruments, such as credit cards, ATM/debit cards, checks, gift certificates, gift cards, cash-cards, stored value cards and non-financial instruments, such as membership cards, club cards, library cards and the like, solving the aforementioned problems is desired.

### SUMMARY OF THE INVENTION

The present invention is a system and method for customizing designs for credit cards, ATM/debit cards, checks, gift certificates, gift cards, membership cards, and like items with images, text and sound clips using a kiosk, the Internet or stand-alone computer software. In general, a user selects artwork from a stored artwork library, a scanned image, a memory device or an active camera. The user orients the image within a workspace or template, adds and arranges optional text, adds optional sound clips and selects the number of the customized product items desired. Once the product is customized, the user may install a money value on the product, if appropriate, and purchase the customized product.

In one embodiment, the system and method includes operation from a kiosk, i.e., a free-standing structure containing a multimedia computer equipped with a touch-screen display. The computer has a processor, an area of main memory for executing program code under the direction of the processor, a storage device and a bus connecting the processor and the storage device. The storage device has a database for storing program code and data such as pre-selected images and pre-recorded sound clips. The computer may be connected to the Internet, a local area network (LAN) or a wide area network (WAN) by a communication device via a communication interface and other input/output devices and may use ATM protocols. The kiosk may be located in a bank, retail store, shopping mall, or other commercial establishment that may be owned or operated by the issuer of the instrument.

The system and method is modified somewhat when used via the Internet. Here a user may access a server, e.g., a Web server, from a personal computer and add images or sound using input/output devices linked to the personal computer or select images and sound from a database on the server. Once the customized product is prepared and purchased, the product is mailed to the user or to a third party designated by the user. The operation of the system and method via stand-alone personal software is similar to its use over the Internet, except here the user has the added option of directly printing the product in the user's home using an appropriate printer and printing material.

Accordingly, it is a principal object of the invention to allow a user to custom design a financial instrument and non-financial instruments such as a credit card, a check, a gift certificate, a gift card, an ATM/debit card, a cash-card, a stored value card, a membership card and similar items.

It is another object of the invention to allow a user to incorporate a customized photograph or picture onto financial and non-financial instruments such as a credit card, a check, a gift certificate, a gift card, an ATM/debit card, a cash-card, a stored value card and a membership card and similar items.

It is a further object of the invention to allow a user to custom design by incorporating sound clips to financial and non-financial instruments such as a credit card, a check, a gift certificate, a gift card, an ATM/debit card, a cash-card, a stored value card and a membership card and similar items.

Still another object of the invention is to allow a user to incorporate a custom design on financial and non-financial instruments such as a credit card, a check, a gift certificate, a gift card, an ATM/debit card, a cash-card, a stored value card and a membership card and similar items using a Kiosk, the Internet or computer software.

It is an object of the invention to provide improved elements and arrangements thereof for the purposes described which is instantaneous, inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental perspective view of a kiosk for operation of the system and method according to the present invention.

FIG. 2 is a block diagram showing elements of a typical system for practicing the method of the present invention.

FIG. 3A is a front view of an exemplary customized gift card according to the present invention.

FIG. 3B is a rear view of the customized gift card of FIG. 3A.

FIG. 4 is a front view of an exemplary customized check according to the present invention.

FIG. 5A is a flow chart representing the steps in creating a customized instrument according to the method of the present invention.

FIG. 5B is a flow chart representing the steps in selecting artwork to appear on the customized instrument according to the method of the present invention.

Similar reference characters denote corresponding features consistently throughout the attached drawings.

### DETAILED DESCRIPTION OF THE PREFERRED EMBODIMENTS

The present invention is a system and method for customizing designs for credit cards, ATM/debit cards, checks, gift cards and membership cards and similar items with images, text and sound clips using a kiosk, a computer connected to the Internet, or stand-alone computer software. As used herein, the term “instrument” refers to credit cards, ATM/debit cards, checks, gift cards, stored value cards, gift certificates cash cards and membership cards and similar items to be customized according to the present invention.

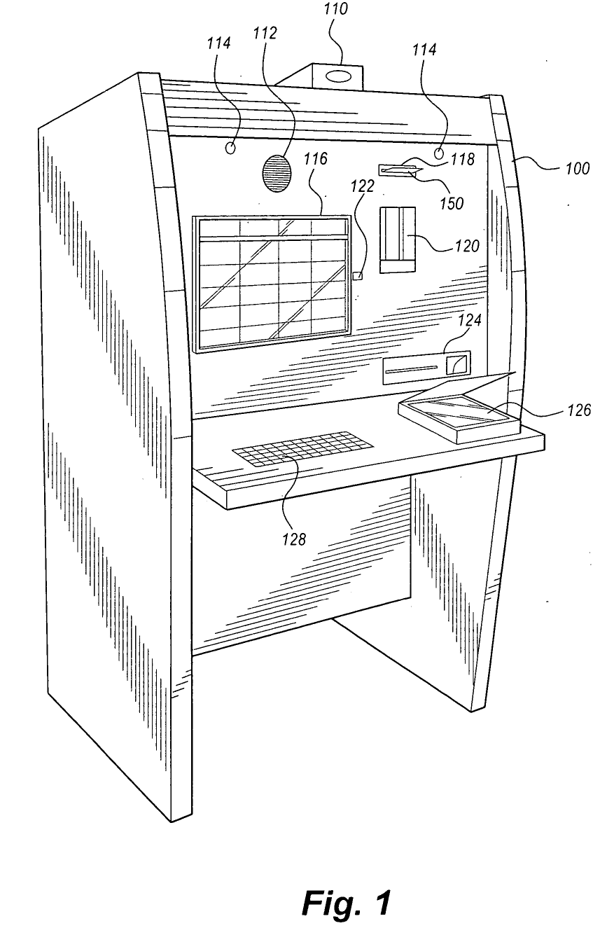

In one embodiment, the system and method extends to providing a kiosk 100 for implementing the invention, as shown in FIG. 1. The kiosk 100 is suited for use in commercial or similar venues, such as retail stores, malls, grocery stores, post offices, fast food restaurants, banks, and other commercial establishments, which may be owned or operated by the issuer of the instrument.

The kiosk 100 presents a user with an opportunity to create instantaneous personalized and custom-made products easily. Similarly, the kiosk 100 presents a vendor with the opportunity to allow its patron to use the system and method for specific and limited uses. For instance, a bank may use the system and method to allow its patrons to specifically customize only credit cards, ATM/debit card, checks, or other financial instruments. Similarly, a mall may use the system and method to specifically create products suitable for its business, such as a mall-wide gift card.

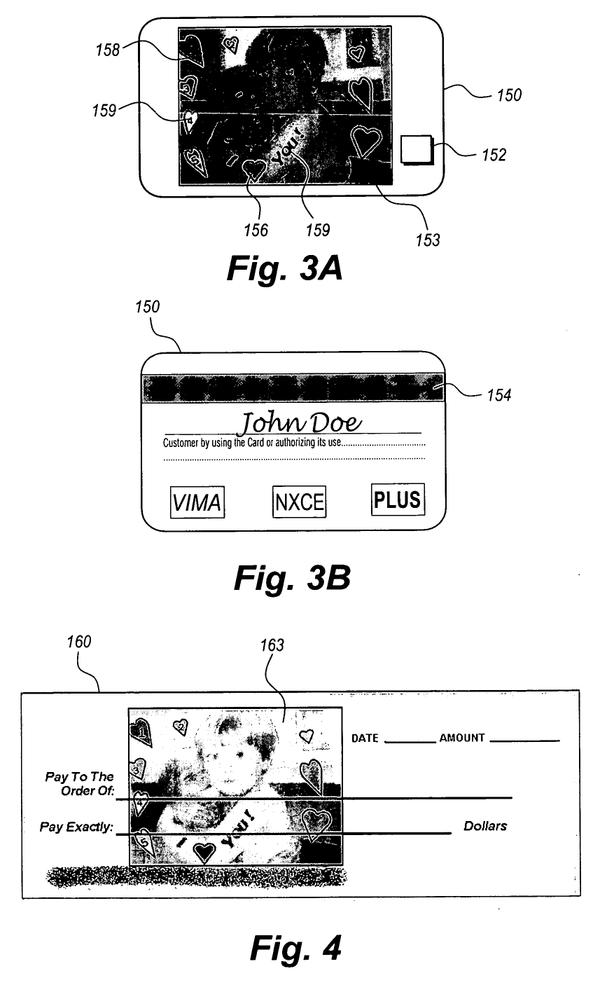

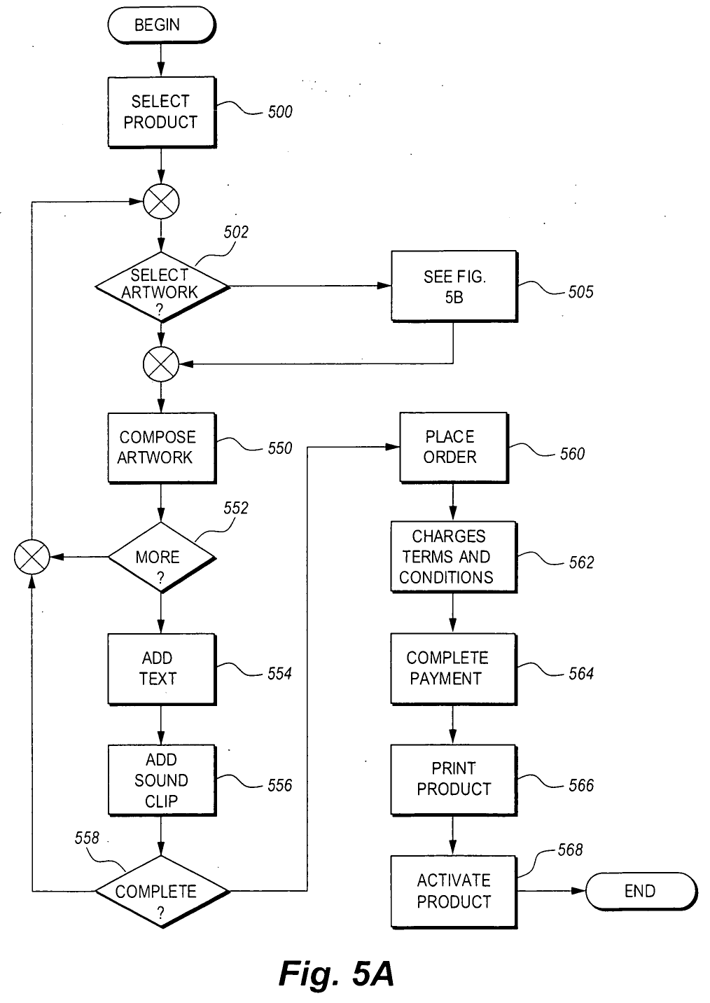

As shown in FIGS. 3A, 3B, and 4, some customized products created by the system and method include financial instruments and non-financial instruments, such as credit cards, ATM/debit cards, checks 160, gift certificates, gift cards 150, membership cards, cash-cards, stored value cards, library cards and similar items. It will be understood that the designs shown in the drawing figures are exemplary only, and may be customized by the user, as described below.

Once the product type is selected, the product is customized by designing artwork to be shown on the selected product with images, text and sound clips. The product is then composed by configuring the artwork in the orientation desired by the user and finalized by selecting the number of products desired, making final payment, and adding money value to the product, if appropriate and desired. The customized product is printed while the user waits or as the consumer continues to shop. The kiosk 100 may display advertisements during the assembly process, as well as while the consumer waits for the product to be printed and between uses.

One example of the product produced by the system and method is the gift card 150 shown in FIGS. 3A and 3B. The customized gift card 150 is designed using artwork, such as a photo 153, combined with graphics 158, text 159 and icons 156. The photo 153 may be placed on the gift card 150 according to the user's preference. As shown in the figures, the photo 153 may be centered on one side of the gift card 150. The photo 153 may be placed on the entire surface, or on only a portion of the work surface, leaving room for a retailer's logo or emblem. Some templates to create the gift card 150 or similar product instrument may have a portion that is sectioned off to display corporate information and logos or emblems.

A sound chip may also be added to the card 150 and triggered by depressing a sound activation button 152. The gift card 150 is preferably made of sturdy material, such as rigid or semi-rigid plastic, and has a magnetic strip 154 for encoding money value. For products other than gift cards, such as membership cards, library cards, credit or debit cards, or the like, the magnetic strip 154 may retain personal identification information, account or membership numbers, and the like. Instead of a magnetic strip 154, a bar code, a smart chip or other form of information storage means may be incorporated into the card.

The kiosk 100 may also be set up to create gift certificates or checks 160. The check 160 shown in FIG. 4 has a photo 163 and would have bank information imprinted thereon, such as the account number for the user creating it and banking identification numbers for the issuing financial institution. Like the gift card 150, the check 160 may incorporate the photo 163 over the entire surface area of the check 160 or any portion of the check 160. The present system and method provides the user with a way of creating personalized products that are suitable for any occasion.

The kiosk 100 is a free-standing structure containing a multimedia computer equipped with a touch-screen display. The computer system 130 is of a generally known and common configuration, which employs a keyboard 128 and touch-screen display 116 as its primary interface means for user input and output. The computer system 130 may instead use the touch-screen display device 116 as the primary interface both for displaying images and data and for receiving user inputs, thus eliminating the need for the keyboard 128.

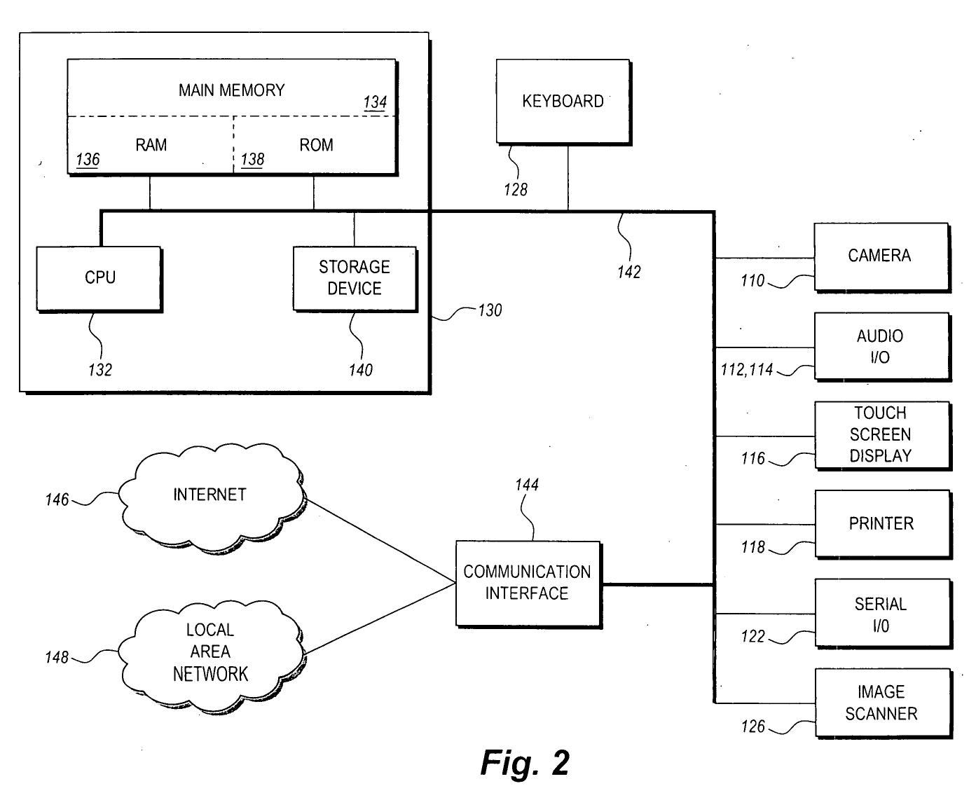

FIG. 2 shows a representative block diagram of a computer system with which the present invention may be carried out. The computer 130 has a processor (CPU) 132, an area of main memory 134 comprising both read only memory (ROM) 136 and random access memory (RAM) 138 for executing program code under the direction of the processor 132, a storage device 140, and a bus 142 connecting the processor 132, the main memory 134 and the storage device 140. The storage device 140 may provide for a database for storing program code and data, such as pre-selected images and pre-recorded sound clips. The bus 142 also connects the computer 130 to a communication device connected to a network, such as the Internet 146, a local area network (LAN) 148, a wide area network (WAN), or other network or workstation via a communication interface 144, as well as input/output devices, such as keyboard 128, camera 110, microphone 112, speakers 114, display 116, printer 118, USB port 122, compact disk drive, receipt printer, computer pen or similar instrument to generate electronic signatures, and scanner 126.

These other input/output devices may be employed for use with the kiosk 100, regardless of whether the computer system 130 uses the touch-screen display 116 and the keyboard 128 individually or in combination. Such devices include a camera 110, audio devices such as a microphone 112 and speakers 114, a display screen 116, a printer 118, a credit card reader 120, a serial input/output device 122, a cash slot 124, a scanner 126, a mouse, a compact disk drive, a receipt printer, a computer pen or similar instrument to generate electronic signatures, and a keyboard 128. It can be recognized that the keyboard 128 interface may be employed for use during installation, configuration, maintenance, and other modes of operation of the system and method.

The serial input/output device 122 may be an RS-232, a Universal Serial Bus (USB) , or other serial interface. Other types of interface that may be employed in communication with specialized devices include digital cameras or the like. The microphone 112 and speakers 114 is provided for recording and playing sound clips, and may include a volume control for controlling the volume of an audio signal output. The kiosk 100 has software residing in memory, or operating in main memory when the computer system 130 operates over the Internet in a client-server configuration, for carrying out the method of the present invention, and may include software operating under ATM protocol with the issuer's server for authenticating or validating account or membership information.

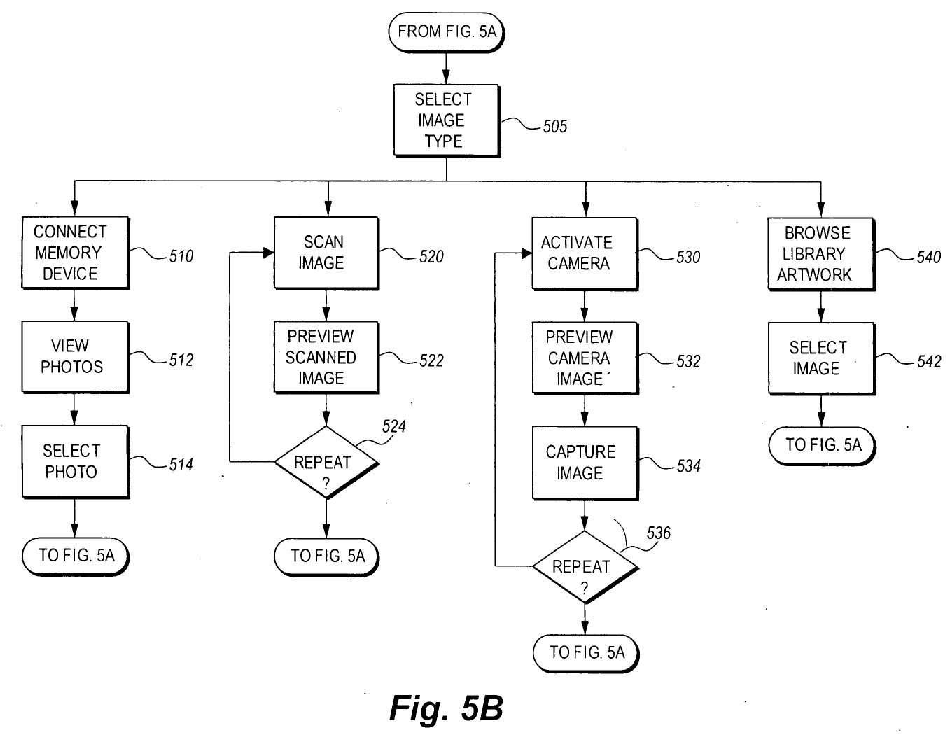

Referring now to FIGS. 5A and 5B, in use the user manipulates the interface devices on the kiosk 100, either the keyboard 128 or the touch-screen display 116, to select the type of product they desire to customize. First, the user is prompted to select a product type for customization at step 500, such as credit cards, ATM/debit cards, checks 160, gift certificates, gift cards 150, membership cards, cash-cards, stored value cards, or similar items. Then, at step 502 the user is invited to design artwork on the product, such as adding images at step 505, text at step 554, and optional sound clips at step 556.

If the user decides to add images, he or she is offered a variety of way to select the image at step 505. The image may be obtained from a stored artwork library at step 540, or from external memory sources, such as from a memory device at step 510, from a scanned image at step 520, or from an active camera at step 530. Once the image source is selected, the image is composed at step 550 or otherwise prepared for printing on the product by editing and manipulating the artwork using various techniques, such as cropping, enlarging, shrinking, rotating and adding effects.

When the image is selected from the memory device at step 510, the user inserts a memory device into the serial I/O connection 122 to upload photos and view the photos at step 512 on a template of the selected product via the display 116. The user then selects a desired photo at step 514 and composes the image on the product at step 550. If the desired image cannot be easily transferred to the kiosk 100 via the serial I/O 122, the user may scan an image at step 520 using the scanner 126. The scanned image may be displayed or previewed at step 522 on a template of the selected product via the display 116. The process may be repeated as indicated at step 524 if more than one image is desired, or if the user decides against using the initially scanned picture. Once the image is scanned at step 520, the image is composed at step 550.

The camera 110 on the kiosk 100 provides the user with the option of taking current and instant pictures, similar to taking photos in an instant photo booth. First, the user must select to activate the camera 110 as indicated at step 530. The user then poses and takes the picture, and the image is previewed at step 532 and captured at step 534. The steps of taking current pictures with the camera 110 can be repeated, as indicated at step 536, if the user desires to take different or additional pictures, the user is unsatisfied with the quality of the picture taken, etc. Once the desired picture or pictures are taken, the picture is composed at step 550 and formatted for use on the product. As with the previous methods of capturing images, a visual representation of the image on the selected template is illustrated on the display 116 to give the user an idea of what the final product will look like.

If the user would rather not use a personal picture, or does not have an image appropriate for the occasion the product is being customized and purchased for, the user may browse for images, photos and artwork from a library at step 540. After the image is selected at step 542 and composed at step 550, a visual representation of the image on the selected template is illustrated on the display 116. The process can be repeated if multiple pictures are desired for use on the product. The library of artwork may be organized into categories, such as sports, nature, holiday, travel, etc. The library may also contain copyrighted or trademarked material, such as art, cartoon characters, celebrity pictures and icons, assuming the appropriate measures are taken to prevent abuse of copyrights and trademarks.

The selected images may be combined with one another at step 552 by repeating the process of selecting artwork and selecting the image type. For instance, the art selected from the library at step 540 may be overlaid on the picture obtained from the camera 110, the scanner 126 or the serial I/O 122.

In continuing the customization and designing of the product, the user is invited to add text at step 554 and sound clips at step 556 appropriate for the occasion. For instance, if the user is customizing the product for a specific event, text may be added using only letters, or a combination of letters and symbols, as shown with the gift card 150. If the product is intended as a birthday present, the user may add text 159, such as “HAPPY BIRTHDAY JENNA”, “FROM ALL OF US”. Similarly, if the event is Valentine's Day the user may decide to add words “I LOVE YOU.” The text may be edited using different fonts and incorporated using the keyboard 128, a stylus, or the like.

Sound clips may also be customized and added to the product. The sound clips are best employed on card-like substrates used to make financial or retail cards, and not on paper surfaces used to create gift certificates or checks. The sound clip may be a recorded voice message, or possibly even a pre-recorded song clip or sound bite. To add the sound clip, the user adds the prerecorded sound to the product or speaks into the microphone 112 and records the message or sound, reviews the sound clip via the speakers 114, and adds it to the product, if satisfactory. A play button 152 may be activated and used on the product to play the recorded sound clip.

Although the system and method for customizing designs gives the user the opportunity to create customized products in any permutation desired using images 153, 163, text 159 and graphic 158, the system and method is easily applicable for those who are creatively limited or who want a pre-crafted product. For instance, at each step where the user is prompted to select artwork, the user may simultaneously be presented with the option to select pre-customized templates for images, text and sound. Such templates can display generic pictures and include standard adage such as “GOOD LUCK”, “CLASS OF 2005”, “HAPPY HOLIDAYS” etc.

Once the images, text and sound are customized, the process of customizing the product is complete, as indicated at step 558. The user continues to finalize the transaction by placing an order at step 560 for a quantity of products to be purchased and selecting whether to add a denomination type to the product. As part of finalizing the product, the user settles terms and conditions, as well as total charges and fees at step 562. The user completes payment at step 564 by selecting the payment type, such as a credit card or ATM/debit card, and swiping it through the credit card slot 120 or paying by cash using the cash slot 124. The product is then printed at step 566 using the printer 118 and is activated at step 568 by swiping the customized product in the credit card reader 120. As mentioned above, advertisements may be displayed on the display 116 while the products are being customized, during printing of the product, and between uses. Alternatively, a second display may be used to show advertisements.

Although the system and method has been described by implementation using the kiosk 100, it is equally operational by accessing a web page over the Internet or using a stand-alone computer software program implementing the method described above. For instance, if the user desires to create the customized product over the Internet, the user may access the web page designated for the creation of the products. The user is then offered the same options presented in FIGS. 5A and 5B.

The user selects the product type, decides to add artwork by selecting an image type chosen from a memory device, a scanned image, an active camera, if equipped, or a stored artwork library. Once the artwork is selected, the artwork is composed and graphics, text, and sound clips may be added. With image, text and sound in place the designing of the product is completed, orders are placed, charges, terms and conditions are settled, and payment is made. The product is then processed, printed, and activated at a place of manufacture designated by the issuer and mailed to the user or to a third party.

Likewise, the system and method may be employed using stand-alone computer software and materials for use on personal computers. The user would follow the same general procedures as described with the kiosk 100 and the Internet. Thus, here, the product is designed and printed at home using the materials provided with the software and using input/output devices already furnished on the personal computer. The product may be activated upon first use in commerce, with use of access codes and the like, alternatively the product may be designed at home and issued from at a place of manufacture and mailed to the user or to a third party.

It is to be understood that the present invention is not limited to the embodiments described above, but encompasses any and all embodiments within the scope of the following claims.

1. A computerized method for customizing an instrument, comprising the steps of:
(a) selecting a product type;
(b) selecting artwork for the selected product type;
(c) composing the artwork; and
(d) finalizing the composed product.

2. The computerized method according to claim 1, wherein the product type is selected from the group consisting of credit cards, ATM/debit cards, checks, gift cards, stored value cards, cash cards, gift certificates and membership cards.

3. The computerized method according to claim 1, wherein step (a) further comprises selecting a non-financial instrument.

4. The computerized method according to claim 1, wherein step (b) further comprises the step of obtaining the artwork from an external memory source.

5. The computerized method according to claim 1, wherein step (b) further comprises capturing and receiving the artwork from an external source.

6. The computerized method according to claim 1, wherein step (b) further comprises obtaining the artwork from a stored artwork library.

7. The computerized method according to claim 1, wherein step (c) further comprises a composing step selected from the group consisting of editing, manipulating, cropping, enlarging, shrinking and adding effects to the artwork.

8. The computerized method according to claim 1, wherein step (c) further includes the step of adding text to the product.

9. The computerized method according to claim 1, wherein step (c) further includes the step of adding sound clips to the product.

10. The computerized method according to claim 1, further comprising the step of printing the product while a user waits.

11. The computerized method according to claim 1, wherein step (d) further comprises selecting a quantity of the products to order.

12. The computerized method according to claim 1, wherein step (d) further comprises adding a denomination value to the product.

13. The computerized method according to claim 1, wherein step (d) further comprises settling total payment charges, fees, terms and conditions for use of the product.

14. The computerized method according to claim 1, wherein step (d) further comprises printing and activating the product.

15. A system for customizing an instrument, comprising:
(a) at least one computer having a processor, an area of main memory for executing program code under the direction of the processor, the main memory having read only memory (ROM). and random access memory (RAM), a storage device and a bus connecting the processor, main memory and the storage device;
(b) a database stored in the storage device
(c) program code stored in the storage device, the program code for executing in said main memory under the direction of said processor, the program code including;
(i) means for selecting a product type;
(ii) means for designing artwork on a product of the product type;
(iii) means for composing the artwork on the product; and
(iv) means for finalizing the composed product.

16. The system of claim 15, wherein the product type is selected from the group consisting of credit cards, ATM/debit cards, checks, gift cards, stored value cards, cash cards, gift certificates and membership cards.

17. The system of claim 15, further comprising a communications device connected to a network.

18. The system of claim 15, wherein said computer is a multimedia computer having a touch-screen, the computer being installed in a kiosk.

19. The system of claim 15, further comprising a kiosk, said computer being a multimedia computer installed in the kiosk and having a touch-screen.

20. The system of claim 15, further comprising a communications device connected to a network, said program code further comprising means for communicating over the network using hypertext transfer protocol. 30
